(19) United States
(12) Patent Application Publication
(10) Pub. No.: US 2010/0210480 A1
(43) Pub. Date: Aug. 19, 2010

(54) USE OF INVERT EPOXY EMULSIONS FOR WELLBORE STABILIZATION

(75) Inventors: David Antony Ballard, Aberdeenshire (GB); Andrew Burn, Edson (CA)

Correspondence Address: OSHA LIANG/MI, TWO HOUSTON CENTER, 909 FANNIN STREET, SUITE 3500, HOUSTON, TX, 77010, US

(73) Assignee: M-I LLC, Houston, TX (US)

(21) Appl. No.: 12/600,945

(22) PCT Filed: May 7, 2008
(86) PCT No.: PCT/US08/62921

§ 371 Date: Apr. 2, 2010

Related U.S. Application Data
(60) Provisional application No. 60/939,727, filed on May 23, 2007.

(51) Int. Cl. C09K 8/32; C09K 8/508

(52) U.S. Cl. 507/117; 507/219

(57) ABSTRACT

An invert emulsion wellbore fluid, including: a continuous oleaginous phase; a discontinuous non-oleaginous phase; a stabilizing agent; an oil-immiscible epoxy-based resin; and a hardening agent; wherein the wellbore fluid is a stable emulsion having a viscosity greater than 200 cps. In some embodiments, the hardening agent is an oil-miscible hardening agent; in other embodiments, the hardening agent is an oil-immiscible hardening agent.

### BACKGROUND OF DISCLOSURE

1. Field of the Disclosure

Embodiments disclosed herein relate generally to invert emulsions that may be used to strengthen a wellbore. In another aspect, embodiments disclosed herein relate to invert emulsions that include epoxy resins, epoxy hardeners or curing agents, and other additives for improving wellbore stability and wellbore strength.

2. Background

Lost circulation is a recurring drilling problem, characterized by loss of drilling mud into downhole formations that are fractured, highly permeable, porous, cavernous, or vugular. These earth formations can include shale, sands, gravel, shell beds, reef deposits, limestone, dolomite, and chalk, among others. Other problems encountered while drilling and producing oil and gas include stuck pipe, hole collapse, loss of well control, and loss of or decreased production.

Induced mud losses may also occur when the mud weight, required for well control and to maintain a stable wellbore, exceeds the fracture resistance of the formations. A particularly challenging situation arises in depleted reservoirs, in which the drop in pore pressure weakens hydrocarbon-bearing rocks, but neighboring or inter-bedded low permeability rocks, such as shales, maintain their pore pressure. This can make the drilling of certain depleted zones impossible because the mud weight required to support the shale exceeds the fracture resistance of the sands and silts.

Other situations arise in which isolation of certain zones within a formation may be beneficial. For example, one method to increase the production of a well is to perforate the well in a number of different locations, either in the same hydrocarbon bearing zone or in different hydrocarbon bearing zones, and thereby increase the flow of hydrocarbons into the well. The problem associated with producing from a well in this manner relates to the control of the flow of fluids from the well and to the management of the reservoir. For example, in a well producing from a number of separate zones (or from laterals in a multilateral well) in which one zone has a higher pressure than another zone, the higher pressure zone may disembogue into the lower pressure zone rather than to the surface. Similarly, in a horizontal well that extends through a single zone, perforations near the “heel” of the well, i.e., nearer the surface, may begin to produce water before those perforations near the “toe” of the well. The production of water near the heel reduces the overall production from the well.

During the drilling process, muds are circulated downhole to remove rock as well as deliver agents to combat the variety of issues described above. Mud compositions may be water or oil-based (including mineral oil, biological, diesel, or synthetic oils) and may comprise weighting agents, surfactants, proppants, and gels. In attempting to cure these and other problems, loss control material (LCM) pills, and cement squeezes have been employed. Gels, in particular, have found utility in preventing mud loss, stabilizing and strengthening the wellbore, and zone isolation and water shutoff treatments.

In many wells, water-based and oil-based muds are both used. Water-based muds are generally used early in the drilling process. Later, oil-based muds are substituted as the well gets deeper and reaches the limit of the water-based muds due to limitations such as lubricity and well bore stabilization. The majority of gels employ water compatible gelling and crosslinking agents, as exemplified by U.S. Patent Application Publication No. 20060011343 and U.S. Pat. Nos. 7,008,908 and 6,165,947, which are useful when using water-based muds.

Accordingly, there exists a continuing need for improved drilling materials and fluids. Specifically, there exists a continuing need for drilling fluids for improving wellbore stability and for wellbore strengthening.

### SUMMARY OF THE DISCLOSURE

In one aspect, embodiments disclosed herein relate to an invert emulsion wellbore fluid, including: a continuous oleaginous phase; a discontinuous non-oleaginous phase; a stabilizing agent; an oil-immiscible epoxy-based resin; and a hardening agent; wherein the wellbore fluid is a stable emulsion having a viscosity greater than 200 cps. In some embodiments, the hardening agent is an oil-miscible hardening agent; in other embodiments, the hardening agent is an oil-immiscible hardening agent.

In another aspect, embodiments disclosed herein relate to a process for strengthening a wellbore, including: admixing an oleaginous fluid, a non-oleaginous fluid, a stabilizing agent, an oil-immiscible epoxy-based resin, and a hardening agent to form a stable invert emulsion having a viscosity greater than 200 cps; placing the invert emulsion into a wellbore; and reacting the oil-immiscible epoxy-based resin and the oil-soluble hardening agent.

In another aspect, embodiments disclosed herein relate to a process for strengthening a wellbore, including: placing an invert emulsion into a wellbore, wherein the invert emulsion comprises an oleaginous fluid, a non-oleaginous fluid, a stabilizing agent, and an oil-immiscible epoxy-based resin, and wherein the invert emulsion has a viscosity greater than 200 cps; placing an emulsion comprising a hardening agent in the wellbore; and reacting the oil-immiscible epoxy-based resin and the hardening agent.

Other aspects and advantages will be apparent from the following description and the appended claims.

### DETAILED DESCRIPTION

In one aspect, embodiments disclosed herein relate to invert emulsions that may be used to strengthen a wellbore and to increase wellbore stability. In another aspect, embodiments disclosed herein relate to invert emulsions that include epoxy resins, hardeners or curing agents, and other additives for improving wellbore stability and wellbore strength. In other aspects, embodiments disclosed herein relate to invert emulsions that include epoxy resins and hardeners, wherein the epoxy resin and hardener are in different phases of the emulsion.

Wellbore fluids or muds described herein may include oleaginous fluids (diesel, mineral oil, or a synthetic compound, for example) and non-oleaginous fluids (water, brine, and others, for example), weighting agents, bentonite clay, and various additives that serve specific functions. Wellbore fluids disclosed herein include invert emulsions, having an oleaginous fluid as the continuous phase.

Wellbore Strengthening

In some embodiments, invert emulsions described herein include an epoxy resin and an epoxy hardener, or curing agent, wherein the epoxy resin and hardener are in different phases. For example, in an invert emulsion, an oil-immiscible epoxy resin may be in the discontinuous non-oleaginous phase, and an epoxy hardener may be in the continuous oleaginous phase. In this manner, epoxy resin-containing droplets may concentrate and build up on the surface of the wellbore and in the near wellbore region, which may then react with the hardener in the continuous phase, thus increasing the strength of the subterranean formation through which the wellbore passes. As used herein, the terms “miscible” and “soluble” are used interchangeably to indicate that components, epoxy resin and hardeners, may be compatible, miscible, or dissolved with the phase indicated, oleaginous or non-oleaginous.

In some embodiments, an epoxy-resin based invert emulsion may be formed by emulsifying oil-immiscible epoxy based resins, individually or dissolved in a non-oleaginous fluid, into a continuous oleaginous phase, including use of surfactants, emulsifiers, or surface active agents, to result in a stable (i.e., minimal coalescence of emulsified epoxy resin) invert emulsion having an oleaginous continuous phase and a non-oleaginous discontinuous phase. The oleaginous-continuous emulsion formed may then be mixed with an oil-soluble or oil-miscible hardening agent and other components, including viscosifiers. The emulsion may have a viscosity greater than 200 centipoise and other suitable properties for pumping and placement in a wellbore. The invert emulsion may then be placed in the wellbore and near wellbore region, where the oil-immiscible epoxy resin may harden.

In another embodiment, an invert emulsion may be formed by emulsifying oil-immiscible epoxy based resins, individually or dissolved in a non-oleaginous fluid, into a continuous oleaginous phase, including use of viscosifiers, surfactants, emulsifiers, or surface active agents, to result in a stable (i.e., minimal coalescence of emulsified epoxy resin) invert emulsion, having an oleaginous continuous phase and a non-oleaginous discontinuous phase, and having a viscosity greater than 200 centipoise. The invert emulsion may then be placed in the wellbore and near wellbore region, where the oil-immiscible epoxy resin droplets may concentrate and build up on the surface of the wellbore. The concentrated droplets may then be contacted with an invert emulsion formed with an oil-soluble hardening agent, causing the oil-immiscible epoxy resin to harden. Similarly, in other embodiments, the oil-soluble hardening agent may be allowed to concentrate on the surface followed by sequential treatment with the invert epoxy emulsion having an oil-immiscible epoxy resin.

In other embodiments, invert emulsions described herein include an epoxy resin and an epoxy hardener, or curing agent, wherein the epoxy resin and hardener are in the same phase. For example, in an invert emulsion, an oil-immiscible epoxy resin may be in the non-oleaginous phase, and an epoxy hardener may be also be in the non-oleaginous phase. In this manner, epoxy resin-containing droplets may concentrate and build up on the surface of the wellbore and in the near wellbore region, which may then react with the hardener, thus increasing the strength of the subterranean formation through which the wellbore passes.

In some embodiments, an epoxy-resin based invert emulsion may be formed by emulsifying oil-immiscible epoxy based resins, individually or dissolved in a non-oleaginous fluid, into a continuous oleaginous phase, including use of surfactants, emulsifiers, or surface active agents, to result in a stable invert emulsion having a non-oleaginous discontinuous phase and an oleaginous continuous phase. The oleaginous-continuous emulsion formed may then be mixed with an oil-immiscible hardening agent and other components, including viscosifiers. The invert emulsion may have a viscosity greater than 200 centipoise and other suitable properties for pumping and placement in a wellbore. The invert emulsion may then be placed in the wellbore and near wellbore region, where the oil-immiscible epoxy resin may harden.

In another embodiment, an invert emulsion may be formed by emulsifying oil-immiscible epoxy based resins, individually or dissolved in a non-oleaginous fluid, into a continuous oleaginous phase, including use of viscosifiers, surfactants, emulsifiers, or surface active agents, to result in a stable invert emulsion, having a non-oleaginous continuous phase and an oleaginous discontinuous phase, and having a viscosity greater than 200 centipoise. The invert emulsion may then be placed in the wellbore and near wellbore region, where the oil-immiscible epoxy resin droplets may concentrate and build up on the surface of the wellbore. The concentrated droplets may then be contacted with an invert emulsion formed with an oil-immiscible hardening agent, causing the oil-immiscible epoxy resin to harden. Similarly, in other embodiments, the oil-immiscible hardening agent may be allowed to concentrate on the surface followed by sequential treatment with the invert epoxy emulsion having an oil-immiscible epoxy resin.

Water-based wellbore fluids may have an aqueous fluid as the continuous phase and an oleaginous fluid as the discontinuous phase. The aqueous fluid may include at least one of fresh water, sea water, brine, mixtures of water and water-soluble organic compounds, and mixtures thereof. For example, the aqueous fluid may be formulated with mixtures of desired salts in fresh water. Such salts may include, but are not limited to alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, silicon, lithium, and salts of chlorides, bromides, carbonates, iodides, chlorates, bromates, formates, nitrates, sulfates, phosphates, oxides, and fluorides. Salts that may be incorporated in a brine may include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

Oil-based drilling fluids are generally used in the form of invert emulsion muds. Invert emulsion fluids, i.e. emulsions in which a non-oleaginous fluid is the discontinuous phase and an oleaginous fluid is the continuous phase, may be employed in drilling processes for the development of oil or gas sources, as well as, in geothermal drilling, water drilling, geoscientific drilling and mine drilling. Specifically, the invert emulsion fluids are conventionally utilized for such purposes as providing stability to the drilled hole, forming a thin filter cake, lubricating the drilling bore and the downhole area and assembly, and penetrating salt beds without sloughing or enlargement of the drilled hole. An invert emulsion mud typically consists of three-phases: an oleaginous phase, a non-oleaginous phase and a finely divided particle phase. Also typically included are emulsifiers and emulsifier systems, weighting agents, fluid loss additives, viscosity regulators and the like, for stabilizing the system as a whole and for establishing the desired performance properties. Full particulars can be found, for example, in the article by P. A. Boyd et al entitled “New Base Oil Used in Low-Toxicity Oil Muds” in the Journal of Petroleum Technology, 1985, 137 to 142 and in the Article by R. B. Bennet entitled “New Drilling Fluid Technology-Mineral Oil Mud” in Journal of Petroleum Technology, 1984, 975 to 981 and the literature cited therein. Also, reference is made to the description of invert emulsions found in Composition and Properties of Drilling and Completion Fluids, 5th Edition, H. C. H. Darley, George R. Gray, Gulf Publishing Company, 1988, pp. 328-332, the contents of which are hereby incorporated by reference.

The oleaginous fluid may be a liquid, and more preferably is a natural or synthetic oil, such as diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof. The concentration of the oleaginous fluid should be sufficient so that an invert emulsion forms and may be less than about 99% by volume of the invert emulsion. In one embodiment the amount of oleaginous fluid is from about 30% to about 95% by volume and more preferably about 40% to about 90% by volume of the invert emulsion fluid. The oleaginous fluid in one embodiment may include at least 5% by volume of a material selected from the group including esters, ethers, acetals, dialkylcarbonates, hydrocarbons, and combinations thereof.

The non-oleaginous fluid used in the formulation of the invert emulsion fluid disclosed herein is a liquid and preferably is an aqueous liquid. More preferably, the non-oleaginous liquid may be selected from the group including sea water, a brine containing organic and/or inorganic dissolved salts, liquids containing water-miscible organic compounds and combinations thereof. The amount of the non-oleaginous fluid is typically less than the theoretical limit needed for forming an invert emulsion. Thus in one embodiment the amount of non-oleaginous fluid is less that about 70% by volume and preferably from about 1% to about 70% by volume. In another embodiment, the non-oleaginous fluid is preferably from about 5% to about 60% by volume of the invert emulsion fluid. The fluid phase may include either an aqueous fluid or an oleaginous fluid, or mixtures thereof.

The methods used in preparing both invert emulsion fluids utilized in the methods of the present disclosure are not critical. Specifically, with respect to the invert emulsion fluids, conventional methods may be used to prepare the invert emulsion fluids in a manner analogous to those normally used to prepare oil-based drilling fluids. In one representative procedure, a desired quantity of oleaginous fluid, such as diesel oil, is mixed with the selected emulsifier, and any other additives, such as viscosifying agents and wetting agents. The non-oleaginous phase is prepared by combining selected components into the non-oleaginous fluid with continuous mixing.

Epoxy Resin

The epoxy resins used in embodiments disclosed herein may vary and include conventional and commercially available epoxy resins, which may be used alone or in combinations of two or more, including, for example, novalac resins, isocyanate modified epoxy resins, and carboxylate adducts, among others. In choosing epoxy resins for compositions disclosed herein, consideration should not only be given to properties of the final product, but also to viscosity and other properties that may influence the processing of the resin composition and the drilling fluid. The epoxy resins used may also depend upon the type of emulsion, direct or invert, and one skilled in the art will be able to determine which epoxy resins are suitable for the desired application.

The epoxy resin component may be any type of epoxy resin useful in molding compositions, including any material containing one or more reactive oxirane groups, referred to herein as “epoxy groups” or “epoxy functionality.” Epoxy resins useful in embodiments disclosed herein may include mono-functional epoxy resins, multi- or poly-functional epoxy resins, and combinations thereof. Monomeric and polymeric epoxy resins may be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two or more epoxy groups per molecule. In some embodiments, epoxy resins may also include reactive —OH groups, which may react at higher temperatures with anhydrides, organic acids, amino resins, phenolic resins, or with epoxy groups (when catalyzed) to result in additional crosslinking.

In general, the epoxy resins may be glycidated resins, cycloaliphatic resins, epoxidized oils, and so forth. The glycidated resins are frequently the reaction product of a glycidyl ether, such as epichlorohydrin, and a bisphenol compound such as bisphenol A; C₄ to C₂₈ alkyl glycidyl ethers; C₂ to C₂₈ alkyl-and alkenyl-glycidyl esters; C₁ to C₂₈ alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphynyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms. Other examples of epoxy resins useful in embodiments disclosed herein include bis-4,4′-(1-methylethylidene) phenol diglycidyl ether and (chloromethyl) oxirane bisphenol A diglycidyl ether.

In some embodiments, the epoxy resin may include glycidyl ether type; glycidyl-ester type; alicyclic type; heterocyclic type, and halogenated epoxy resins, etc. Non-limiting examples of suitable epoxy resins may include cresol novolac epoxy resin, phenolic novolac epoxy resin, biphenyl epoxy resin, hydroquinone epoxy resin, stilbene epoxy resin, and mixtures and combinations thereof.

Suitable polyepoxy compounds may include resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidyl ether of bromobispehnol A (2,2-bis(4-(2,3-epoxypropoxy)-3-bromo-phenyl)propane), diglydicylether of bisphenol F (2,2-bis(p-(2,3-epoxypropoxy)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds. A more exhaustive list of useful epoxy resins found may be found in Lee, H. and Neville, K., Handbook of Epoxy Resins, McGraw-Hill Book Company, 1982 reissue.

Other suitable epoxy resins include polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate. Epoxy resins may also include glycidyl derivatives of one or more of: aromatic diamines, aromatic monoprimary amines, aminophenols, polyhydric phenols, polyhydric alcohols, polycarboxylic acids.

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-napthalene dicarboxylic acid, and dimerized linoleic acid; polyglycidyl ethers of polyphenols, such as, for example, bis-phenol A, bis-phenol F, 1,1-bis(4-hydroxyphenyl)ethane, 1,1-bis(4-hydroxyphenyl)isobutane, and 1,5-dihydroxy napthalene; other diglycidyl ethers such as neopentyl glycol diglycidyl ether, 1,4-butanediol diglycidyl ether, polypropylene glycol diglycidyl ether; poly-glycol diglycidyl ether, 1,6-hexanediol diglycidyl ether, dibromo neopentyl glycol diglycidyl ether; triglycidyl ethers, such as trimetylopropane triglycidyl ether, castor oil triglycidyl ether, propoxylated glycerin triglycidyl ether; sorbitol polyglycidyl ether; cyclohexanedimethanol diglycidyl ether modified epoxy resins with acrylate or urethane moieties; glycidlyamine epoxy resins; and novolac resins.

The epoxy compounds may be cycloaliphatic or alicyclic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate; vinylcyclohexene diepoxide; limonene diepoxide; dicyclopentadiene diepoxide; and the like. Other suitable diepoxides of cycloaliphatic esters of dicarboxylic acids are described, for example, in U.S. Pat. No. 2,750,395.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexylmethyl-3,4-epoxy-2-methylcyclohexane carboxylate; 3,4-epoxy-3-methylcyclohexyl-methyl-3,4-epoxy-3-methylcyclohexane carboxylate; 3,4-epoxy-5-methylcyclohexyl-methyl-3,4-epoxy-5-methylcyclohexane carboxylate and the like. Other suitable 3,4-epoxycyclohexylmethyl-3,4-epoxycyclohexane carboxylates are described, for example, in U.S. Pat. No. 2,890,194.

Further, epoxy-containing materials which are particularly useful include those based on glycidyl ether monomers. Examples are di- or polyglycidyl ethers of polyhydric phenols obtained by reacting a polyhydric phenol with an excess of chlorohydrin such as epichlorohydrin. Such polyhydric phenols include resorcinol, bis(4-hydroxyphenyl)methane (known as bisphenol F), 2,2-bis(4-hydroxyphenyl)propane (known as bisphenol A), 2,2-bis(4′-hydroxy-3′,5′-dibromophenyl)propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Another class of epoxy compounds are polyglycidyl esters and poly(beta-methylglycidyl) esters of polyvalent carboxylic acids such as phthalic acid, terephthalic acid, tetrahydrophthalic acid or hexahydrophthalic acid. A further class of epoxy compounds are N-glycidyl derivatives of amines, amides and heterocyclic nitrogen bases such as N,N-diglycidyl aniline, N,N-diglycidyl toluidine, N,N,N′,N′-tetraglycidyl bis(4-aminophenyl)methane, triglycidyl isocyanurate, N,N′-diglycidyl ethyl urea, N,N′-diglycidyl-5,5-dimethylhydantoin, and N,N′-diglycidyl-5-isopropylhydantoin.

Still other epoxy-containing materials are copolymers of acrylic acid esters of glycidol such as glycidylacrylate and glycidylmethacrylate with one or more copolymerizable vinyl compounds. Examples of such copolymers are 1:1 styrene-glycidylmethacrylate, 1:1 methyl-methacrylateglycidylacrylate and a 62.5:24:13.5 methylmethacrylate-ethyl acrylate-glycidylmethacrylate.

Epoxy compounds that are readily available include octadecylene oxide; glycidylmethacrylate; D.E.R. 331 (bisphenol A liquid epoxy resin) and D.E.R. 332 (diglycidyl ether of bisphenol A) available from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl) adipate; bis(2,3-epoxycyclopentyl)ether; aliphatic epoxy modified with polypropylene glycol; dipentene dioxide; epoxidized polybutadiene; silicone resin containing epoxy functionality; flame retardant epoxy resins (such as a brominated bisphenol type epoxy resin available under the tradename D.E.R. 580, available from The Dow Chemical Company, Midland, Mich.); 1,4-butanediol diglycidyl ether of phenolformaldehyde novolac (such as those available under the tradenames D.E.N. 431 and D.E.N. 438 available from The Dow Chemical Company, Midland, Mich.); and resorcinol diglycidyl ether Although not specifically mentioned, other epoxy resins under the tradename designations D.E.R. and D.E.N. available from the Dow Chemical Company may also be used.

Epoxy resins may also include isocyanate modified epoxy resins. Polyepoxide polymers or copolymers with isocyanate or polyisocyanate functionality may include epoxy-polyurethane copolymers. These materials may be formed by the use of a polyepoxide prepolymer having one or more oxirane rings to give a 1,2-epoxy functionality and also having open oxirane rings, which are useful as the hydroxyl groups for the dihydroxyl-containing compounds for reaction with diisocyanate or polyisocyanates. The isocyanate moiety opens the oxirane ring and the reaction continues as an isocyanate reaction with a primary or secondary hydroxyl group. There is sufficient epoxide functionality on the polyepoxide resin to enable the production of an epoxy polyurethane copolymer still having effective oxirane rings. Linear polymers may be produced through reactions of diepoxides and diisocyanates. The di- or polyisocyanates may be aromatic or aliphatic in some embodiments.

Other suitable epoxy resins are disclosed in, for example, U.S. Pat. Nos. 7,163,973, 6,632,893, 6,242,083, 7,037,958, 6,572,971, 6,153,719, and 5,405,688 and U.S. Patent Application Publication Nos. 20060293172 and 20050171237, each of which is hereby incorporated herein by reference.

As described below, curing agents may include epoxy functional groups. These epoxy-containing curing agents and toughening agents should not be considered herein part of the above described epoxy resins.

Curing Agent

A hardener or curing agent may be provided for promoting crosslinking of the epoxy resin composition to form a polymer composition. As with the epoxy resins, the hardeners and curing agents may be used individually or as a mixture of two or more. Additionally, the curing agent or hardener used may also depend upon the type of emulsion, direct or invert, and one skilled in the art will be able to determine which hardeners and curing agents are suitable for the desired application.

Curing agents may include primary and secondary polyamines and their adducts, anhydrides, and polyamides. For example, polyfunctional amines may include aliphatic amine compounds such as diethylene triamine, triethylene tetramine, tetraethylene pentamine, as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine, may also be used. In some embodiments, curing agents may include monoamines, diamines, triamines, secondary amines, polyamines, and polyetheramines sold under the tradename JEFFAMINE, available from Huntsman Corp., The Woodlands, Tex.

Anhydride curing agents may include, for example, nadic methyl anhydride, hexahydrophthalic anhydride, trimellitic anhydride, dodecenyl succinic anhydride, phthalic anhydride, methyl hexahydrophthalic anhydride, tetrahydrophthalic anhydride, and methyl tetrahydrophthalic anhydride, among others.

The hardener or curing agent may include a phenol-derived or substituted phenol-derived novolac or an anhydride. Non-limiting examples of suitable hardeners include phenol novolac hardener, cresol novolac hardener, dicyclopentadiene phenol hardener, limonene type hardener, anhydrides, and mixtures thereof.

In some embodiments, the phenol novolac hardener may contain a biphenyl or naphthyl moiety. The phenolic hydroxy groups may be attached to the biphenyl or naphthyl moiety of the compound. This type of hardener may be prepared, for example, according to the methods described in EP915118A1. For example, a hardener containing a biphenyl moiety may be prepared by reacting phenol with bismethoxy-methylene biphenyl.

In other embodiments, curing agents may include dicyandiamide, boron trifluoride monoethylamine, and diaminocyclohexane. Curing agents may also include imidazoles, their salts, and adducts. These epoxy curing agents are typically solid at room temperature. Examples of suitable imadazole curing agents are disclosed in EP906927A1. Other curing agents include aromatic amines, aliphatic amines, anhydrides, and phenols.

In some embodiments, the curing agents may be an amino compound having a molecular weight up to 500 per amino group, such as an aromatic amine or a guanidine derivative. Examples of amino curing agents include 4-chlorophenyl-N,N-dimethyl-urea and 3,4-dichlorophenyl-N,N-dimethyl-urea.

Other examples of curing agents useful in embodiments disclosed herein include: 3,3′- and 4,4′-diaminodiphenylsulfone; methylenedianiline; bis(4-amino-3,5-dimethylphenyl)-1,4-diisopropylbenzene available as EPON 1062 from Shell Chemical Co.; and bis(4-aminophenyl)-1,4-diisopropylbenzene available as EPON 1061 from Shell Chemical Co.

Thiol curing agents for epoxy compounds may also be used, and are described, for example, in U.S. Pat. No. 5,374,668. As used herein, “thiol” also includes polythiol or polymercaptan curing agents. Illustrative thiols include aliphatic thiols such as methanedithiol, propanedithiol, cyclohexanedithiol, 2-mercaptoethyl-2,3-dimercaptosuccinate, 2,3-dimercapto-1-propanol(2-mercaptoacetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethyleneglycol dithioglycolate, trimethylolpropane tris(beta-thiopropionate), tris-mercaptan derivative of tri-glycidyl ether of propoxylated alkane, and dipentaerythritol poly(beta-thiopropionate); halogen-substituted derivatives of the aliphatic thiols; aromatic thiols such as di-, tris- or tetra-mercaptobenzene, bis-, tris- or tetra-(mercaptoalkyl)benzene, dimercaptobiphenyl, toluenedithiol and naphthalenedithiol; halogen-substituted derivatives of the aromatic thiols; heterocyclic ring-containing thiols such as amino-4,6-dithiol-sym-triazine, alkoxy-4,6-dithiol-sym-triazine, aryloxy-4,6-dithiol-sym-triazine and 1,3,5-tris(3-mercaptopropyl) isocyanurate; halogen-substituted derivatives of the heterocyclic ring-containing thiols; thiol compounds having at least two mercapto groups and containing sulfur atoms in addition to the mercapto groups such as bis-, tris- or tetra(mercaptoalkylthio)benzene, bis-, tris- or tetra(mercaptoalkylthio)alkane, bis(mercaptoalkyl) disulfide, hydroxyalkylsulfidebis(mercaptopropionate), hydroxyalkylsulfidebis(mercaptoacetate), mercaptoethyl ether bis(mercaptopropionate), 1,4-dithian-2,5-diolbis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol and 2,5-dimercapto-1,3,4-thiadiazol.

The curing agent may also be a nucleophilic substance such as an amine, a tertiary phosphine, a quaternary ammonium salt with a nucleophilic anion, a quaternary phosphonium salt with a nucleophilic anion, an imidazole, a tertiary arsenium salt with a nucleophilic anion, and a tertiary sulfonium salt with a nucleophilic anion.

Aliphatic polyamines that are modified by adduction with epoxy resins, acrylonitrile, or (meth)acrylates may also be utilized as curing agents. In addition, various Mannich bases can be used. Aromatic amines wherein the amine groups are directly attached to the aromatic ring may also be used.

Quaternary ammonium salts with a nucleophilic anion useful as a curing agent in embodiments disclosed herein may include tetraethyl ammonium chloride, tetrapropyl ammonium acetate, hexyl trimethyl ammonium bromide, benzyl trimethyl ammonium cyanide, cetyl triethyl ammonium azide, N,N-dimethylpyrrolidinium cyanate, N-methylpyrridinium phenolate, N-methyl-o-chloropyrridinium chloride, methyl viologen dichloride and the like.

Stabilizing Agent/Surface Active Agent/Emulsifier

As used herein, the terms “surface active agent,” “surfactant,” and “emulsifier” or “emulsifying agent” are used interchangeably to indicate the component of the invert emulsion drilling fluid that stabilizes the emulsion. One of ordinary skill in the art should appreciate that such a compound acts at the interface of the oleaginous and the non-oleaginous fluids and lowers the differences in surface tension between the two layers. In the present disclosure, it is important that the emulsifying agent is not adversely affected by the presence of acid or other components in the non-oleaginous phase of the emulsion. The ability of any particular emulsifying agent to stabilize the invert emulsions disclosed herein may be tested by routine experimentation as known in the art. In addition, if the emulsifying agent is to be useful in the formulation of a drilling fluid, the emulsifier should be thermally stable. That is to say, the emulsifier must not break down or chemically degrade upon heating to temperatures typically found in a downhole environment. This may be tested by heat aging the emulsifier. A suitable emulsifier within the scope of embodiments described herein should be capable of stabilizing the direct or invert emulsion under conditions of negative alkalinity and heat aging.

Stabilizing agents may include amines and esters as described in U.S. Patent Application Publication Nos. 20010051593, 20030114316, 20030158046, and 20040072696, assigned to the assignee of the present disclosure and incorporated herein by reference. In other embodiments, organophilic clays, such as amine treated clays, may be useful as emulsion stabilizers in the fluid composition of the present disclosure. Other emulsifiers, such as oil soluble polymers, polyamide resins, polycarboxylic acids and soaps may also be used. Emulsifiers may be used at about 0.1% to 6% by weight of the drilling fluid, which is sufficient for most applications. VG-69™ and VG-PLUS™ are organoclay materials, available from M-I L.L.C., Houston, Tex., that may be used in embodiments disclosed herein.

In some embodiments, surfactants suitable for invert emulsions may include low HLB surfactants. Low HLB surfactants may include amidoamines, sorbitol esters, and alkyl ethers, among others. In other embodiments, invert emulsions may be formed using colloidal materials such as fumed silica, clay, hydroxyl ethyl cellulose, carboxy methyl cellulose, sodium polyacrylate, xanthan gum, modified starch, lignnosulphonates, and tannins.

Other Components/Additives/Weighting Agents

The invert emulsion fluids disclosed herein may further contain additional chemicals depending upon the end use of the fluid so long as they do not interfere with the functionality of the fluids (particularly the emulsion when using invert emulsion displacement fluids) described herein. Other additives that may be included in the wellbore fluids disclosed herein include for example, weighting agents, wetting agents, organophilic clays, viscosifiers, fluid loss control agents, surfactants, dispersants, interfacial tension reducers, pH buffers, mutual solvents, thinners, thinning agents and cleaning agents. The addition of such agents should be well known to one of ordinary skill in the art of formulating drilling fluids and muds.

An additive that may be optionally included in the wellbore fluid disclosed herein includes a fibrous material. One of ordinary skill in the art should appreciate that the use of “inert” fibrous materials can be added to reduce excess fluids by soaking up these fluids. Examples of such materials include gross cellulose, peanut hulls, cotton seed hulls, woody material, and other plant fibers that should be well known to one of skill in the art. In some embodiments, the wellbore fluid may also include from about 3 to about 25 pounds per barrel of a fibrous material. M-I-X II™ and VINSEAL™ are examples of fibrous materials that may be used according to some embodiments, and are commercially available from M-I L.L.C., Houston, Tex.

Another typical additive to oleaginous drilling fluids that may optionally be included in the oleaginous drilling fluids disclosed herein is a fluid loss control agent. Fluid loss control agents may act to prevent the loss of fluid to the surrounding formation by reducing the permeability of the barrier of solidified wellbore fluid. Suitable fluid loss control agents may include those such as modified lignites, asphaltic compounds, gilsonite, organophilic humates prepared by reacting humic acid with amides or polyalkylene polyamines, and other non-toxic fluid loss additives. Usually such fluid loss control agents are employed in an amount which is at least from about 3 to about 15 pounds per barrel. The fluid-loss reducing agent should be tolerant to elevated temperatures, and inert or biodegradable. ECOTROL RD™, a fluid control agent that may be used in the wellbore fluid, is commercially available from M-I L.L.C., Houston, Tex.

The wellbore fluids may further contain additional chemicals depending upon the end use of the invert emulsion. For example, wetting agents, organophilic clays, viscosifiers, rheological modifiers, alkalinity agents, scavengers, weighting agents, and bridging agents may be added to the fluid compositions described herein for additional functional properties. The addition of such agents should be well known to one of skill in the art of formulating drilling fluids and muds. However, it should be noted that the addition of such agents should not adversely interfere with the properties associated with the ability of the components to solidify as described herein.

Wetting agents that may be used in embodiments described herein may include crude tall oil, oxidized crude tall oil, surfactants, organic phosphate esters, modified imidazolines and amidoamines, alkyl aromatic sulfates and sulfonates, and the like, and combinations or derivatives of these. However, the use of fatty acid wetting agents should be minimized so as to not adversely affect the reversibility of the invert emulsion disclosed herein. VERSAWET™ and VERSAWET™ NS are examples of commercially available wetting agents manufactured and distributed by M-I LLC, Houston, Tex. that may be used.

Organophilic clays, typically amine treated clays, may be useful as viscosifiers in the fluid compositions described herein. Other viscosifiers, such as oil soluble polymers, polyamide resins, polycarboxylic acids and soaps may also be used. The amount of viscosifier used in the composition may vary depending upon the end use of the composition. However, normally about 0.1% to 6% by weight is a sufficient range for most applications. VG-69™ and VG-PLUS™ are organoclay materials distributed by M-I LLC, and Versa-HRP™ is a polyamide resin material manufactured and distributed by M-I LLC, that may be used.

Weighting agents or density materials suitable for use in some embodiments include galena, hematite, magnetite, iron oxides, illmenite, barite, siderite, celestite, dolomite, calcite, and the like. The quantity of such material added, if any, depends upon the desired density of the final composition. Typically, weight material is added to result in a drilling fluid density of up to about 24 pounds per gallon. The weight material is preferably added up to 21 pounds per gallon and most preferably up to 19.5 pounds per gallon.

As mentioned above, embodiments of the present disclosure may provide for treatment fluids or pills that may be used to stabilize unconsolidated or weakly consolidated regions of a formation. Wellbore stability may also be enhanced by the injection of an epoxy resin-containing emulsion into formations along the wellbore, where the epoxy-resin and epoxy hardening agent are in distinct phases. The epoxy resin and hardener may react, strengthening the formation along the wellbore upon hardening of the mixture.

In other embodiments, epoxy-based emulsions may be used to combat the thief zones or high permeability zones of a formation. Upon hardening, epoxy-based emulsions injected into the formation may partially or wholly restrict flow through the highly conductive zones. In this manner, the hardened epoxy may effectively reduce channeling routes through the formation, forcing the treating fluid through less porous zones, and potentially decreasing the quantity of treating fluid required and increasing the oil recovery from the reservoir.

In other embodiments, hardened epoxy resins may form part of a filter cake, minimizing seepage of drilling fluids to underground formations and lining the wellbore. As another example, embodiments disclosed herein may be used as one component in loss circulation material (LCM) pills that are used when excessive seepage or circulation loss problems are encountered, requiring a higher concentration of loss circulation additives. LCM pills are used to prevent or decrease loss of drilling fluids to porous underground formations encountered while drilling.

The fluid loss pill or diverting treatment may be injected into a work string, flow to the bottom of the wellbore, and then out of the work string and into the annulus between the work string and the casing or wellbore. This batch of treatment is typically referred to as a “pill.” The pill may be pushed by injection of other completion fluids behind the pill to a position within the wellbore which is immediately above a portion of the formation where fluid loss is suspected. Injection of fluids into the wellbore is then stopped, and fluid loss will then move the pill toward the fluid loss location. Positioning the pill in a manner such as this is often referred to as “spotting” the pill. Components of the fluid loss pill or diverting treatment may then react to form a plug near the wellbore surface, to significantly reduce fluid flow into the formation. As described above, the emulsion injected may include both the hardening agent and epoxy resin, or may be sequentially injected.

The fluid loss pill or diverting treatment may be selectively emplaced in the wellbore, for example, by spotting the pill through a coil tube or by bullheading. A downhole anemometer or similar tool may be used to detect fluid flows downhole that indicate where fluid may be lost to the formation. The relative location of the fluid loss may be determined such as through the use of radioactive tags present along the pipe string. Various methods of emplacing a pill known in the art are discussed, for example, in U.S. Pat. Nos. 4,662,448, 6,325,149, 6,367,548, 6,790,812, 6,763,888, which are herein incorporated by reference in their entirety.

### EXAMPLES

### Example 1

### Invert Emulsions

Samples 1-3, described below, are based on 10 ml DF1 base oil (available from Total Petrochemicals, Houston, Tex.) added to a glass vial to which an initial addition of surfactant/viscosifier is made. The samples are then mixed using high speed agitation to initially disperse the surfactant/viscosifier and then to disperse the subsequently added epoxy into droplets. This is followed by mixing on a high shear ULTRA TURRAX® (available from IKA, Wilmington, N.C.) mixer to emulsify the droplets. If the emulsion is unstable, further additions are made and mixing performed until a stable emulsion is produced, i.e., the emulsion appeared homogeneous one hour after mixing. After leaving the emulsions to stand for 1 hour, 0.5 g Lime and 5 ml JEFFAMINE® T3000 (Huntsman, Houston, Tex.) was then added to samples 1, 2, 3 and they were aged at 70° C. for 16 hrs after which the gel hardness was measured.

The gel hardness can be measured by using a Brookfield QTS-25 Texture Analysis Instrument. This instrument consists of a probe of changeable design that is connected to a load cell. The probe may be driven into a test sample at specific speeds or loads to measure the following parameters or properties of a sample: springiness, adhesiveness, curing, breaking strength, fracturability, peel strength, hardness, cohesiveness, relaxation, recovery, tensile strength burst point, and spreadability. The hardness may be measured by driving a 4 mm diameter, cylindrical, flat faced probe into the gel sample at a constant speed of 30 mm per minute. When the probe is in contact with the gel, a force is applied to the probe due to the resistance of the gel structure until it fails, which is recorded via the load cell and computer software. As the probe travels through the sample, the force on the probe is measured. The force on the probe may be recorded providing an indication of the gel's overall hardness. For example, the initial peak force may be recorded at the point the gel first fails, close to the first contact point, followed by recording highest and lowest values measured after this point where the probe is traveling through the bulk of the gel. The Samples and test results for the Samples are provided in Table 1 below.

Samples 1-3 are made with the following components as detailed in Table 1: EMI 759, an oil soluble polymeric surfactant supplied by M-I LLC (Houston, Tex.); sorbitol polyglycidyl ether (ERISYS™ GE-60, available from CVC Specialty Chemicals Inc.);

Sample 1

5 ml sorbitol polyglycidyl ether (ERISYS™ GE-60, available from CVC Specialty Chemicals Inc.) is added to 2 ml EMI 759, an oil soluble polymeric surfactant supplied by M-I LLC. After mixing, some coarse emulsion droplets are formed that quickly separate. A further addition of 0.2 g hydrophobic Fumed Silica (AEROSIL® R974, Degussa), results in coarse emulsion droplets and the solution having a low viscosity. A further addition of 0.2 g hydrophobic R974 hydrophobic Fumed Silica and mixing results in a dispersion having fine droplets and low viscosity, with some slight settlement after 1 hour

Sample 2

5 ml GE-60 is added to 1 ml EMI 759 and 0.2 g VG-SUPREME™ (a rheological additive available from M-I LLC). After mixing, coarse emulsion droplets are formed. A further 0.2 g VG-SUPREME™ addition results in a dispersion having medium viscosity and fine droplets.

Sample 3

5 ml GE-60 is added to 1 ml CRILL™4 (a low-HLB non-ionic sorbitan ester surfactant supplied by Croda). After mixing, the solution quickly separates. A further addition of 0.4 g VG-SUPREME™ results in a dispersion having medium viscosity and fine droplets.

TABLE 1

| | | Initial | Bulk | Bulk |
|---|---|---|---|---|
| Sample | Description | Peak (g) | Low (g) | High (g) |
| 1 | EMI759 & R974 & GE-60 | 1091 | 423 | 1184 |
| 2 | EMI759 & VGS & GE60 | 1473 | 895 | 2272 |
| 3 | CRILL 4 & VGS & GE60 | 923 | 626 | 1144 |

As described above, invert emulsions may be provided in a wide range of formulations to result in gels that may be used to strengthen a wellbore. The wide range of formulating options available to produce a range of gels of varying physical properties and set times may advantageously be optimised for a specific applications and conditions. Also, the data indicates that viscosifying solids, specifically organoclay, may be a factor in stabilizing the dispersion/emulsion.

Advantageously, embodiments disclosed herein provide for invert emulsions that may be used to strengthen wellbores, combat thief zones, and prevent fluid loss. Embodiments described herein may advantageously provide for a single emulsion or for sequential addition of emulsions that may be used to strengthen wellbores, combat thief zones, and prevent fluid loss.

Additionally, embodiments disclosed herein may advantageously provide an effective means for delivering epoxy-based resins and hardeners to the desired formation, with minimal reaction of the epoxy-based resin prior to placement. By maintaining the hardener and epoxy resin in distinct phases, the reaction may be delayed until the fluid is placed. Additionally, it has unexpectedly been found that combinations of hardeners and epoxy resins, although typically not soluble in the same phase, may be used in direct or invert emulsions to result in gels that may be used to strengthen wellbores, combat thief zones, and prevent fluid loss.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. An invert emulsion wellbore fluid, comprising:
a continuous oleaginous phase;
a discontinuous non-oleaginous phase;
a stabilizing agent;
an oil-immiscible epoxy-based resin; and
a hardening agent;
wherein the wellbore fluid is a stable emulsion having a viscosity greater than 200 cps.

2. The invert emulsion of claim 1, wherein the hardening agent is an oil-miscible hardening agent.

3. The invert emulsion of claim 1, wherein the hardening agent is an oil-immiscible hardening agent.

4. The invert emulsion wellbore fluid of claim 1, wherein the epoxy-based resin comprises at least one of bisphenol A, bisphenol F, resorcinol, novalac resins, and glycidyl ethers of ethylene glycol, 1,4-butanediol, polyglycol, 1,6-hexanediol, and sorbitol polyglycidyl ether, and combinations thereof.

5. The invert emulsion wellbore fluid of claim 1, wherein the stabilizing agent comprises at least one of low HLB surfactants and colloidal solids.

6. The invert emulsion wellbore fluid of claim 1, wherein the hardening agent comprises at least one of an amine and an anhydride.

7. The invert emulsion wellbore fluid of claim 1, further comprising at least one of alkaline earth oxides, calcium carbonate, barite, graphite, and fibrous material.

8. A process for strengthening a wellbore, comprising:
admixing an oleaginous fluid, a non-oleaginous fluid, a stabilizing agent, an oil-immiscible epoxy-based resin, and a hardening agent to form a stable invert emulsion having a viscosity greater than 200 cps;
placing the invert emulsion into a wellbore; and
reacting the oil-immiscible epoxy-based resin and the oil-soluble hardening agent.

9. The process of claim 8, wherein the hardening agent is oil-miscible.

10. The process of claim 8, wherein the hardening agent is oil-immiscible.

11. The process of claim 8, wherein the epoxy-based resin comprises at least one of bisphenol A, bisphenol F, resorcinol, novalac resins, and glycidyl ethers of ethylene glycol, 1,4-butanediol, polyglycol, 1,6-hexanediol, and sorbitol polyglycidyl ether, and combinations thereof.

12. The process of claim 8, wherein the stabilizing agent comprises at least one of low HLB surfactants and colloidal solids.

13. The process of claim 8, wherein the hardening agent comprises at least one of an amine and an anhydride.

14. The process of claim 8, wherein the invert emulsion further comprises at least one of alkaline earth oxides, calcium carbonate, barite, graphite, and fibrous material.

15. A process for strengthening a wellbore, comprising:
placing an invert emulsion into a wellbore, wherein the invert emulsion comprises an oleaginous fluid, a non-oleaginous fluid, a stabilizing agent, and an oil-immiscible epoxy-based resin, and wherein the invert emulsion has a viscosity greater than 200 cps;
placing an emulsion comprising a hardening agent in the wellbore; and
reacting the oil-immiscible epoxy-based resin and the hardening agent.

16. The process of claim 15, wherein the hardening agent is oil-immiscible.

17. The process of claim 15, wherein the hardening agent is oil-miscible.

18. The process of claim 15, wherein the placing the emulsion comprising the hardening agent is prior to the placing of the invert emulsion.

19. The process of claim 15, wherein the placing the invert emulsion is prior to the placing the emulsion comprising the hardening agent.

20. The process of claim 15, wherein the epoxy-based resin comprises at least one of bisphenol A, bisphenol F, resorcinol, novalac resins, and glycidyl ethers of ethylene glycol, 1,4-butanediol, polyglycol, 1,6-hexanediol, and sorbitol polyglycidyl ether, and combinations thereof.

21. The process of claim 15, wherein the stabilizing agent comprises at least one of low HLB surfactants and colloidal solids.

22. The process of claim 15, wherein the hardening agent comprises at least one of an amine and an anhydride.

23. The process of claim 11, wherein the invert emulsion further comprises at least one of alkaline earth oxides, calcium carbonate, barite, graphite, and fibrous material.
